(19) United States
(12) Patent Application Publication
(10) Pub. No.: US 2010/0168979 A1
(43) Pub. Date: Jul. 1, 2010

(54) DETERMINATION OF THE AIR PLAY IN A BRAKE WITH TWO DIRECTIONS APPLICATION DEVICES

(76) Inventors: Christian Baier-Welt, Ober-Ramstadt (DE); Richard Roberts, Gilching (DE); Martin Schautt, Munchen (DE)

Correspondence Address: King & Spalding LLP, 401 Congress Avenue, Suite 3200, Austin, TX, 78701, US

(21) Appl. No.: 12/524,094

(22) PCT Filed: Jan. 14, 2008
(86) PCT No.: PCT/EP08/50353

§ 371 Date: Jan. 29, 2010

(30) Foreign Application Priority Data
Jan. 30, 2007 (DE) 10 2007 004 604.0

(51) Int. Cl. G06F 17/00; F16D 65/14; F16D 65/62; F16D 66/02

(52) U.S. Cl. 701/76; 188/1.11 W

(57) ABSTRACT

In a method for determining an electrical operating variable, in particular the air play (L) and/or zero position (N) of a brake (1) having a friction element (12) which can be pressed in at least two application directions (A, B) against the friction surface of an element (14) to be braked, the air play or the zero position can be determined in a simple and precise manner by virtue of the friction element (12) being placed into a first and a second point of contact (K1, K2) with the element (14) to be braked, the position x1, x2 of the contact points K1, K2 being detected by means of sensors, and the operating variable (L, N) which is sought being determined therefrom.

### CROSS-REFERENCE TO RELATED APPLICATIONS

This application is a U.S. National Stage Application of International Application No. PCT/EP2008/050353 filed Jan. 14, 2008, which designates the United States of America, and claims priority to German Application No. 10 2007 004 604.0 filed Jan. 30, 2007, the contents of which are hereby incorporated by reference in their entirety.

### TECHNICAL FIELD

The invention relates to a method for determining an operating variable, in particular the air gap and/or the zero position of a brake, as well as a brake having a controller.

### BACKGROUND

Known electromagnetic brakes, which are referred to below, include an electrically-operated actuator, usually an electric motor, which presses a friction element having a brake pad against or releases it from an element to be braked, such as a brake disk for example. Wear occurs in the break pads during operation. It is therefore usually necessary to adjust the pads in the direction of the brake disk in order to ensure the operation of the brake again.

On the other hand, in certain driving situations, for example prolonged driving downhill or hard braking from high speed, an enlargement in the brake pads due to thermal heating can occur and this reduces the air gap. In this case it can be necessary to increase the air gap.

In order to adjust the air gap between brake pad and brake disk, various pad wear adjustment devices are known, for example those described in DE 10139910 A1, DE 10227271 B4 or DE 102 14669 A1. With electromagnetic brakes, in particular wedge brakes, the adjustment travel of the brake pads is comparatively small and must not exceed a relatively narrow range. For safe brake operation it is therefore particularly important to determine the air gap between brake pad and brake disk as accurately as possible and adjust it as required. This is often unsatisfactory with the known methods and devices.

In the case of brakes with shafts subject to slip, a sensor is present, for example, by which the zero point of the brake and thus also the air gap are able to be measured. Due to the slip of the shaft this can no longer be achieved with precision, especially after repeated reversing operations.

SUMMARY

According to various embodiments, a device and a method can be developed by means of which a characteristic operating variable, in particular the air gap and/or the zero-point position of an electromagnetic brake, in particular a wedge brake, can be simply determined with sufficient accuracy.

According to an embodiment, in a method for determining an operating variable, in particular the air gap and/or the zero position, of a brake having a friction element, which can be moved in at least two application directions against the friction surface of an element to be braked, the friction element is placed into a first and a second point of contact with the element to be braked, the position of the contact points is detected by sensors and the operating variable which is sought is determined therefrom.

According to a further embodiment, both the contacts points can be approached in the same direction, namely each in the application direction or in the release direction, in order to measure the position of the contact points. According to a further embodiment, the friction element can be moved beyond the contact points up to a reversal point. According to a further embodiment, starting from a released position of the brake the friction element can be moved in the direction of the first contact point. According to a further embodiment, the air gap can be calculated according to the following relationship: L=C*/2. According to a further embodiment, the zero position can be calculated according to the following relationship: N=C*/2.

According to a further embodiment, an offset of a force sensor can be determined. According to a further embodiment, the air gap can be determined according to one of the above described methods and for the subsequent determination of the air gap the friction element can be moved into only one contact point, whose positions are determined, and the air gap is determined from the position of the contact point and the previously determined zero position. According to a further embodiment, the method can be carried out sequentially at different wheels of a motor vehicle. According to a further embodiment, the air gap may have a specified maximum value and when the maximum value is exceeded an adjusting device of the brake is actuated to reduce the air gap. According to a further embodiment, the air gap may be compared to a minimum value and when the value falls below the minimum value the air gap is increased by means of an adjusting device. According to a further embodiment, a plausibility check of the sensor signals of a position sensor and of a force sensor can be carried out. According to a further embodiment, the absolute value and/or the gradient of the sensor signals can be compared to specified values.

According to another embodiment, a control device for determining an operating variable, in particular the air gap and/or the zero position of a brake may include means for implementing one of the preceding methods as described above.

### BRIEF DESCRIPTION OF THE DRAWINGS

By way of example, the invention is explained in more detail below with the aid of the attached drawings, where

FIG. 1 shows a schematic view of a wedge brake which is designed for braking operations in the forwards and backwards direction;

FIG. 2 shows a force/displacement brake characteristic curve when the procedure is running;

FIG. 3 shows the main method steps of a procedure to determine the air gap, in the form of a flowchart;

FIG. 4 shows the main method steps of a plausibility check;

FIG. 5a shows the force/displacement characteristic curve where the air gap is too wide;

FIG. 5b shows the force/displacement characteristic curve where there is no air gap; and

FIG. 5c shows the force/displacement characteristic curve where the air gap is too narrow.

### DETAILED DESCRIPTION

According to various embodiments, the friction element of the brake is placed at least once in a first and a second point of contact with the element to be braked, the position of the contact points is detected by means of sensors, and the operating variable which is sought, in particular the air gap and/or the zero position, is determined therefrom. This procedure is preferably carried out automatically and has the significant advantage that it is particularly simple and delivers very precise results. A prerequisite for this is that the brake in question is a brake that is designed for forwards and backwards braking operations, that is to say it has a first and a second direction of application. There are thus two points of contact—one during actuation in the first application direction and the other during actuation in the second application direction.

According to various embodiments, both of the contact points are preferably in the same direction, that is to say each is approached in the application direction or in the release direction. Consequently, hysteresis effects which occur as a result of the viscoelastic properties of the brake pads can be avoided and the accuracy of the measurement improved.

Within the context of the measurement procedure according to various embodiments, the friction element is preferably actuated beyond the respective contact point up to a reversal point.

The contact between the brake pad and the element to be braked can be determined by means of a force sensor, for example. In this case, the contact point is visible by a “knee” in the measurement characteristic curve. The force sensor is preferably positioned in the path of the braking force.

Basically, the position of the contact points can be determined with any position sensor, such as a displacement sensor or angular resolver, for example. The position sensor can, for example, be mounted on the shaft of the brake actuator and measure its angle of rotation.

In principle, the procedure according to various embodiments can be started from any position of the brake. According to an embodiment the procedure is started from a released position of the brake and each of the two contact points are approached with increasing force gradients and the position of the contact points measured at the same time.

The air gap L is preferably calculated from the positions of the two contact points. If x₁ and x₂ are the positions of the two contact points, the air gap can, for example, be calculated according to the following relationship:

L=C*(a1*x₁−b1*x₂)/2

Here a1 and b1 are factors for different wedge angles in the forwards and backwards direction.

The zero position N of the wedge brake, that is to say the point at which the wedge flanks for forwards and backwards braking operations intersect, can for example be calculated from the following relationship:

N=C*(a2*x₁+b2*x₂)/2.

a2 and b2 are again factors for different wedge angles in the forwards and backwards direction.

Furthermore, in the context of the procedure according to various embodiments, a possible force sensor offset can also be determined. The force sensor offset results from the minimal value of the sensor signal between the two contact points during the execution of the method. If the air gap and/or the zero position of the brake has been determined once, it is subsequently no longer absolutely necessary to approach both contact points in order to determine the air gap again. Rather, knowing the zero position it is sufficient to move the friction element to only one contact point to determine its position and ascertain the current air gap (simplified method) therefrom.

Regarding the application to wheel brakes of motor vehicles, the procedure according to various embodiments can be run either on a plurality of wheels or sequentially. The (full or simplified) procedure according to various embodiments is intended to be carried out at regular intervals. In addition, it can also be run according to specific driving situations, such as after a prolonged downhill descent or hard braking from high speed. According to a further embodiment, the measured air gap is compared to a setpoint value or a setpoint range and, if it differs from the setpoint value or range, is preferably automatically corrected. If, for example, the air gap exceeds a specified maximum value (Lₘₐₓ) the air gap is automatically reduced. On the other hand, if it is less than a specified minimum value (Lₘᵢₙ) it is increased and thus restored to an optimum value range.

Both the sensor output signals (of the force or position sensor) and the operating variables (air gap, zero position or offset) derived therefrom are preferably subjected to a plausibility check. In the course of this, for example, an absolute value or gradient check can be carried out. The method described above is preferably implemented as software in a brake control unit which correspondingly automatically controls the brake actuator or the actuator of the adjusting device.

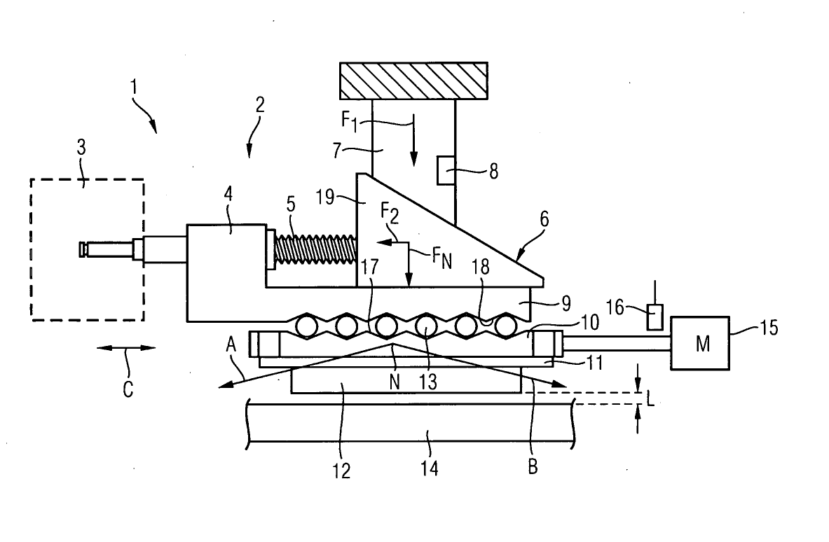

FIG. 1 shows a side view of an electromechanical disk brake 1 for motor vehicles, with a pad wear adjusting device 2. Here the brake is realized as a wedge brake and contains an actuator 15 for actuating an active wedge plate 10. At its front side (below in the diagram) the wedge plate 10 has a pad carrier 11, to which a brake pad 12 is attached. Several wedge faces 17 which are in the form of a zigzag, are arranged on its rear side.

A fixed wedge plate 9, which has corresponding zigzag-shaped wedge faces 18 on its front side, acts as a thrust block for the moving wedge plate 10. Several rolling elements 13, which essentially serve to improve the sliding friction, are provided between the two wedge plates 9, 10. The wedge faces 17, 18 can be designed differently for braking operations in the forwards and backwards direction.

In order to apply or release the brake 1, the active wedge plate 10 is driven by the actuator 15 in the operating direction C (to the left or to the right). At the same time, the rolling elements 13 travel upwards or downwards along the wedge faces 17, and the active wedge plate 10 is moved towards or away from the brake disk 14.

In this case the wedge brake 1 is constructed so that it can be deployed when driving in the forwards as well as in the backwards direction. For braking operations in the forwards direction, the active wedge plate 10 is displaced in a first application direction (for example A), and in a second application direction (for example B) for braking operations in the backwards direction. In both cases a self-reinforcing effect occurs as soon as the wedge plate 10 is driven by the rotating brake disk 14.

The forces occurring during braking are transmitted to a brake caliper (not shown) via the fixed wedge plate 9, a wedge 19 of the adjusting device 2 and a support 7. The brake caliper can be realized for example as a floating caliper.

The adjusting device 2 includes a wedge 19 which is driven by an actuator 3 via a spindle 5, and positioned in the force flow path of the braking force. In the course of this the wedge face 6 of the wedge 19 acts in combination with a corresponding wedge face of the support 7. By actuating the wedge 19 forwards or backwards, the air gap L can be adjusted as required. When wear occurs in the brake pad 12, the wedge 19 is moved further forward, for example, so that the air gap L is reduced.

The zero position of the active wedge plate 10 is defined by the intersection of the wedge faces 17, 18 for braking operations in the forwards direction and braking operations in the backwards direction. At the same time, this position is the position in which the two wedge plates 9, 10 are lying closest together.

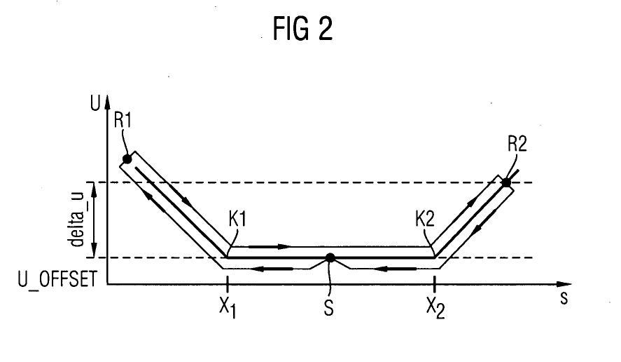

FIG. 2 shows the force/displacement curve in a method for determining the air gap L and/or the zero position N of the brake 1. Here the value s drawn on the x-axis is the distance traveled by the active wedge plate 10 and the value U drawn on the y-axis is the sensor signal of a normal force sensor 8 which is placed in the force flow path of the braking force (see FIG. 1).

To start the method, the active wedge plate 10 is located at any starting point S and from there is first displaced in one direction—in this case in application direction A (see arrow pointing to the left). At the start, the brake pad 12 is still at a distance from the brake disk 14. In this state, the normal force sensor 8 should deliver a signal U=0 V. If, as in this case, the sensor 8 delivers a signal other than zero, this corresponds to the offset of the sensor. As soon as the brake pad 12 contacts the brake disk 14, the sensor signal U increases. A knee which specifies the first contact point K1 can be clearly seen in the characteristic curve. The position x1 of the contact point K1 can be measured, for example, by means of a position sensor such as an angular resolver 16 (see FIG. 1) for instance.

After traveling a specified distance in which the brake 1 is again applied, the direction of travel of the active wedge plate 10 is reversed. The reversal point is denoted by R1. The wedge plate 10 is then again released from the brake disk 14 and subsequently overshoots the zero position N of the brake 1 and then again travels in the second application direction B. The friction element 12 contacts the brake disk 14 at the point x₂. Again, this can be seen by a knee in the characteristic curve. The active wedge plate 10 is then again moved in the application direction B until a reversal point R2 is reached. Following this, the direction of travel is again reversed and the active wedge plate 10 is returned to the starting state S.

This method results in two contact points K1, K2, from whose positions x₁ and x₂ the air gap L or the zero position N of the brake 1 can be calculated.

The following relationship can be formulated for the air gap L:

L=c*(x₁−x₂)/2

The zero position which, with symmetrical wedge faces for forwards and backwards braking operations, corresponds to the geometrical center point, is given by the following relationship:

N=c*(x₁+x₂)/2.

In the case of unequal angles of the wedge faces for braking operation in the forwards and backwards direction, the appropriate geometrical relationships must of course be taken into account in the calculation.

In principle, the offset of the normal force sensor 8 corresponds to the minimum of the force/displacement characteristic curve of FIG. 2.

The position of each of the contact points K1, K2 is preferably measured in the branch with rising or falling force gradients. This means that the measurement is then made in each case when the contact points K1, K2 are approached either in the application direction A or B, or in the release direction. Hysteresis effects due to the viscoelastic properties of the brake pads 12 can be avoided in this way.

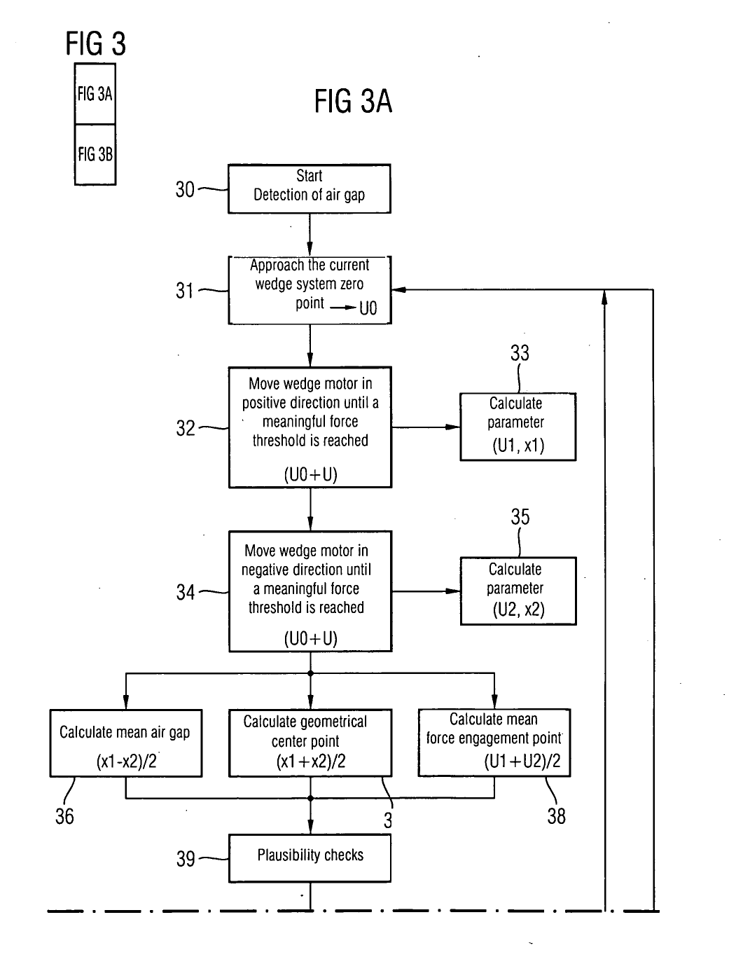

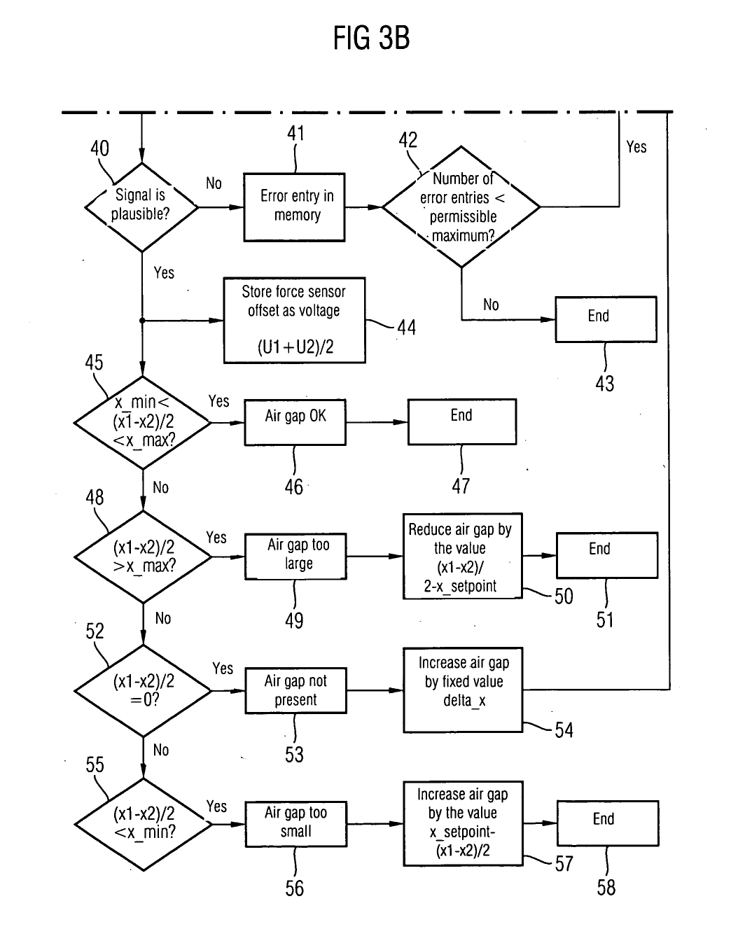

FIG. 3 shows the main method steps of a method for determining air gap L, zero position N and sensor offset of the brake 1. The method commences at step 30 (start). In step 31 the start point S, for example the stored zero point of the wedge brake 1 determined in a preceding braking operation, is approached. After this, the active wedge plate 10 is first driven in the positive application direction A until a force threshold U0+AU has been exceeded (step 32). The position x₁ of the contact point K1 is determined in step 33 from the sensor data of the force sensor 8 and position sensor 16. On reaching the reversal point R1, the active wedge plate 10 is moved in the other direction (step 34) and on reaching the second contact point K2 its position x₂ is again determined (step 35). In steps 36, 37 and 38, the mean air gap L (step 36), the geometrical center point N (step 37) and a mean force engagement point (step 38) are then determined, as described above in relation to FIG. 2.

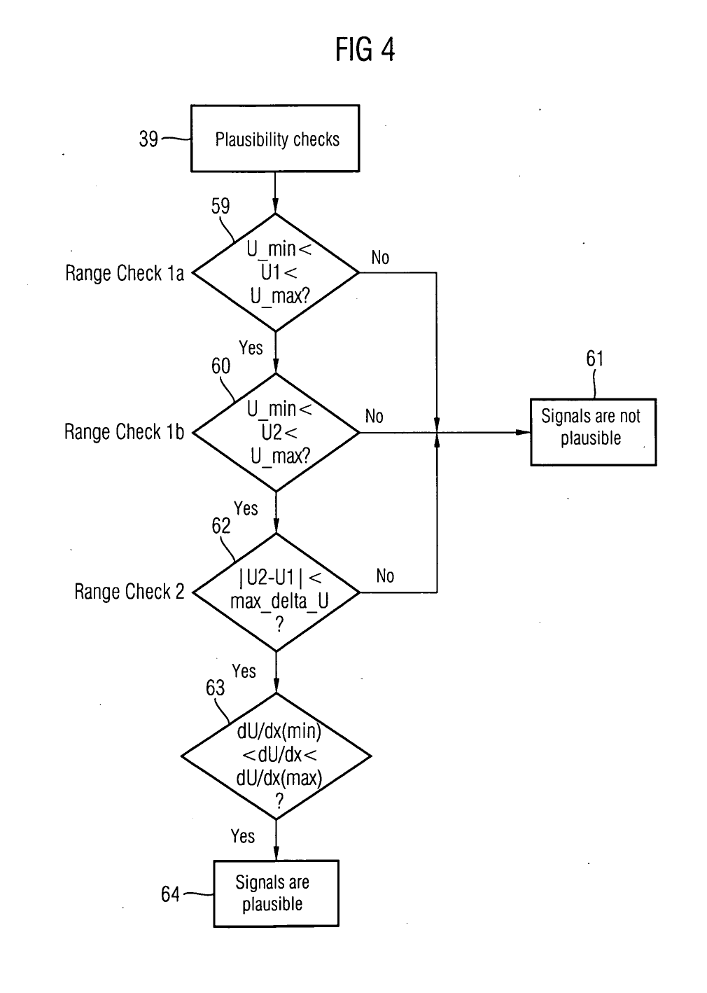

In order to check the determined variables, as well as the sensor signals, a plausibility check, whose individual steps are shown in greater detail in FIG. 4, is carried out in step 39.

If it appears from the plausibility check that the determined values are not plausible, (query in step 40), an error entry is input into a memory in step 41. If the number of error entries exceeds a permissible maximum (query in step 42), the method is ended in step 43. Otherwise (Y) the method returns to step 31.

If the plausibility check of step 40 confirms the validity of the determined measured values, the offset U_{OFFSET} of the normal force sensor 8 is stored. In this case the value 0=(U1+U2)/2 is calculated as the offset.

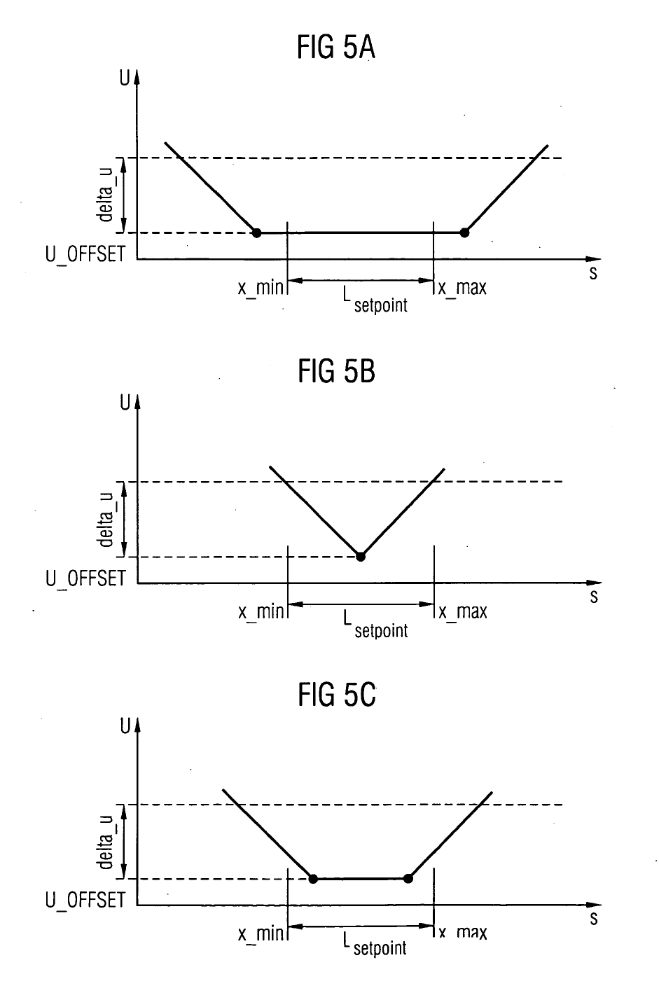

In the following steps 45 to 58, a check is made as to whether the air gap lies within a specified tolerance range. Next, in step 45 it is queried whether the air gap L lies within the limits x_min and x_max (see FIG. 5a). If yes (Y), it is assumed in step 46 that the air gap is OK and the method ends in step 47.

Otherwise (N), it is queried in step 48 whether the air gap is greater than a permissible maximum value x_max. If yes (Y), this is registered in step 49 and the air gap L is automatically reduced. The method then ends in step 51.

In step 52 it is queried whether the air gap L is zero. If yes, this is registered in step 53 and the air gap is increased by a specified value ΔX (see FIG. 5b). The method is then rerun recursively in step 31.

A check is made in step 55 as to whether the air gap L is smaller than a specified minimal value x_min. If yes (Y), this is registered in step 56 and the air gap L is increased in step 57 by a value x_setpoint−L. With that, the method ends in step 58.

FIG. 4 shows the plausibility check (step 39) carried out within the method. Here, in step 59, a check is made as to whether the sensor signal U1 at the position of the first contact point K1 lies within a specified range [U_min; U_max]. Accordingly, if yes (Y), the sensor signal U2 is checked at the second contact point K2 (step 60). If the query is again positive (Y), an additional check is carried out in 62 as to whether the difference between the two signals U1, U2a is less than a maximum value. If the query in one of the steps 59, 60 or 62 is negative (N), the signals are regarded as not plausible (step 71).

Lastly, with a positive result in step 62, a gradient check of the sensor signal U is carried out in step 63. If the gradient lies within a specified range (case Y) the signals are regarded as plausible (step 64).

What is claimed is:

1. A method for determining an operating variable of a brake having a friction element, which can be moved in at least two application directions against the friction surface of an element to be braked,
the method comprising the steps of:
placing the friction element into a first and a second point of contact with the element to be braked,
detecting the position of the contact points by sensors, and
determining the operating variable which is sought from the detected positions.

2. The method according to claim 1,
wherein,
both of the contacts points are approached in the same direction, wherein the direction is the application direction or the release direction, in order to measure the position of the contact points.

3. The method according to claim 1, wherein,
the friction element is moved beyond the contact points up to a reversal point.

4. The method according to claim 1, wherein, starting from a released position of the brake the friction element is moved in the direction of the first contact point.

5. The method according to claim 15, wherein,
the air gap is calculated according to the following relationship:
L=C*(a1*x₁−b1*x₂)/2.

6. The method according to claim 1, wherein,
the zero position is calculated according to the following relationship:
N=C*(a2*x₁+b2*x₂)/2.

7. The method according to claim 1, wherein,
an offset of a force sensor is determined.

8. The method according to claim 1, wherein,
the operating variable is an air gap and wherein for the determination of the air gap the friction element is moved into only one contact point, whose positions are determined, and the air gap is determined from the position of the contact point and the previously determined zero position.

9. The method according to claim 1, wherein,
the method is carried out sequentially at different wheels of a motor vehicle.

10. The method according to claim 15, wherein
the air gap has a specified maximum value and when the maximum value is exceeded an adjusting device of the brake is actuated to reduce the air gap.

11. The method according to claim 15, wherein
the air gap is compared to a minimum value and when the value falls below the minimum value the air gap is increased by means of an adjusting device.

12. The method according to claim 1, wherein
a plausibility check of the sensor signals of a position sensor and of a force sensor is carried out.

13. The method according to claim 12, wherein
at least one of the absolute value and the gradient of the sensor signals is compared to specified values.

14. A control device for determining an operating variable of a brake
having a friction element, which can be moved in at least two application directions against the friction surface of an element to be braked, wherein the control device is operable to place the friction element into a first and a second point of contact with the element to be braked, and comprises sensors to detect the position of the contact points and is further operable to determine the operating variable from said detected positions.

15. The method according to claim 1, wherein the operating variable is at least one of the air gap and the zero position of the brake.

16. The control device according to claim 14, wherein the operating variable is at least one of the air gap and the zero position of the brake.

17. The control device according to claim 14,
Wherein both the contacts points are approached in the same direction, wherein the direction is the application direction or the release direction, in order to measure the position of the contact points.

18. The control device according to claim 14, wherein the friction element is moved beyond the contact points up to a reversal point.

19. The control device according to claim 14, wherein starting from a released position of the brake the friction element is moved in the direction of the first contact point.

20. The control device according to claim 16, wherein the air gap is calculated according to the following relationship:
L=C*/2.
